(19) United States
(12) Patent Application Publication
(10) Pub. No.: US 2006/0206236 A1
(43) Pub. Date: Sep. 14, 2006

(54) System and method for electronically identifying vehicle wheels on-the-fly during manufacture

(76) Inventor: Larry C. Smyth, Annapolis, MD (US)

Correspondence Address: SCHWARTZ LAW FIRM, P.C., 6100 FAIRVIEW ROAD, SUITE 11350, CHARLOTTE, NC, 28210, US

(21) Appl. No.: 10/565,053

(22) PCT Filed: Jul. 19, 2004
(86) PCT No.: PCT/US04/23133

§ 371 Date: Jan. 17, 2006

(30) Foreign Application Priority Data
Jul. 18, 2003 (US) 60488602

(51) Int. Cl. G06F 7/00

(52) U.S. Cl. 700/225

(57) ABSTRACT

The method electronically identifies a vehicle wheel on-the-fly moving downstream from one processing location to another. The method includes the steps of locating a machine-readable identification mark applied to an exposed surface of the vehicle wheel as the vehicle wheel. The identification mark is electronically read on-the-fly.

### TECHNICAL FIELD AND BACKGROUND OF THE INVENTION

The invention relates to a system and method for electronically identifying vehicle wheels on-the-fly during manufacture. The term “manufacture” is used broadly herein to include any sequential processing of the wheel prior to its actual mounting on a vehicle. In addition to vehicle wheels, the general concept of the present invention is applicable to any other item whose identification during or after manufacture is either necessary or desirable.

The manufacturing of cast alloy wheels is generally an ordered process of sequential events. Some of these events are specific to an exact wheel model, while others are not. For example, machining is geometry specific, and if the wrong casting is loaded, a dangerous and expensive crash occurs. Heat-treating, on the other hand is non-specific and the wheel model is not so important. However, as heat-treating is approximately an one shift process, it is still useful to know what is in the furnace for planning the subsequent operations. For reasons as diverse as these it is advantageous to identify wheels during manufacture.

The most common method to identify wheels is by a human operator. However, in higher volume automated operations, this is both expensive and less than 100% reliable. In these cases, sensor-based wheel model recognition systems are desired. Various sensor technologies are applicable, the most prevalent being machine vision. According to this technology, a snapshot of the wheel face is taken and compared against stored values. While this is relatively straightforward for a human operator, it is a considerably more difficult task for machine vision, primarily because the snapshot is only a 2-D (two dimensional) image. Often such systems are only effective when used in parallel with other inputs, and in some cases, series snapshots are required to eliminate the probability of misidentification.

Another method used to identify wheel models is a combination of basic wheel measurements and basic profiling of the wheel face—see, for example, U.S. Pat. No. 6,173,213 to Amiguet et al. This prior art method is used for the critical machining operation, and the profiling is performed by laser distance measurement scans at several concentric diameters. The method is relatively expensive, cannot differentiate wheels that share much common geometry, and takes too much time for inline model identification without the massive parallelism that occurs in wheel machining.

To help human operators readily distinguish between similar model wheels cast from different molds, the side cores are often engraved with mold numbers or letters. This is possible because the side cores form the rim periphery, an area of the wheel casting that invariably is 100% machined. While such lettering is readily seen in fluoroscopic images, and can be machine-recognized by optical character recognition (OCR), this technique is not a practical solution. Conventional machine vision is more realistic. However, the low contrast surface makes this a more difficult task.

The need for automated rapid identification of general products has led to information encoded on one-dimensional bar codes. These all-pervasive linear bar codes are typically high contrast marks, most often black bars on a white background to facilitate reliable and rapid scanning and decoding. When low contrast bar codes are used, they are generally unreliable when read with conventional scanners. A solution for overcoming the low contrast issue is to use a particular type of 2-D bar code, where the bars are either below or above the general surface. By using more sophisticated scanners based on laser distance measurement units, these codes can be reliably read. This type of 2-D bar code is generally referred to as “bumpy bar code.”

Given the relative ease of creating a bumpy bar code in manufactured parts, this model and mold number identification technique is now commonly practiced, thereby promoting the convenience and reliability of automated rapid identification. The technique is particularly common in automotive tire manufacturing, and more recently has been applied to cast wheels, where the bar code is formed in one side core. Bumpy bar code wheel model identification systems take advantage of the roundness of wheels. These systems have a reader station which centers the wheel casting in front of a laser point scanner, and then rotates the encoded rim to keep the background surface at an approximately constant depth. While the system is relatively fast and reliable, it is considerably expensive and inefficient because the conveyed wheel must be stopped at the reader station and then rotated up to 360 degrees in order to locate and scan the code.

### SUMMARY OF INVENTION

Therefore, it is an object of the invention to provide a system and method for electronically identifying vehicle wheels on-the-fly during manufacture without slowing downstream forward movement of the wheel.

It is another object of the invention to provide a system and method which electronically locates and reads the wheel identification mark at the same time.

It is another object of the invention to provide a system and method for marking the vehicle wheel such that the wheel can be reliably machine-identified as it is conveyed into subsequent processes without stopping and rotating the wheel.

These and other objects of the present invention are achieved in the preferred embodiments disclosed below by providing a method for electronically identifying a vehicle wheel on-the-fly moving downstream from one processing location to another. The method includes the steps of locating a machine-readable identification mark applied to an exposed surface of the vehicle wheel. As the vehicle wheel moves downstream, the identification mark is electronically read on-the-fly.

According to another preferred embodiment of the invention, the method includes a first stage reading operation for locating the machine-readable identification mark on the moving vehicle wheel.

According to another preferred embodiment of the invention, the method includes a second stage reading operation downstream of the first stage reading operation for electronically reading the identification mark on the moving vehicle wheel.

According to another preferred embodiment of the invention, the second stage reading operation includes mounting multiple ID scanners at predetermined locations relative to the moving vehicle wheel.

According to another preferred embodiment of the invention, the second stage reading operation includes mounting a single ID scanner at a predetermined location relative to the moving vehicle wheel.

According to another preferred embodiment of the invention, the method includes adjusting the location of the ID scanner relative to the moving vehicle wheel, such that the scanner intercepts the identification mark applied to the vehicle wheel.

According to another preferred embodiment of the invention, the method includes rotating the vehicle wheel between the first and second stage reading operations, such that the identification mark is oriented for interception by the ID scanner.

According to another preferred embodiment of the invention, the method includes locating at least one of multiple machine-readable identification marks applied to a circumference of the vehicle wheel.

According to another preferred embodiment of the invention, the vehicle wheel has at least three equally spaced, machine-readable identification marks.

According to another preferred embodiment of the invention, the identification marks are applied to a rim barrel of the vehicle wheel.

According to another preferred embodiment of the invention, the identification marks are applied to a rim flange of the vehicle wheel.

In another embodiment, the invention is a wheel identification system for electronically identifying a vehicle wheel on-the-fly moving downstream from one processing location to another. The system includes means for locating a machine-readable identification mark applied to an exposed surface of the vehicle wheel. At least one ID scanner electronically reads the identification mark on-the-fly as the vehicle wheel moves downstream.

According to another preferred embodiment of the invention, the means for locating the identification mark includes a camera mounted upstream of the at least one ID scanner.

According to another preferred embodiment of the invention, the means for adjusting the location of said at least one ID scanner relative to the moving vehicle wheel, such that the ID scanner intercepts the identification mark applied to the vehicle wheel.

According to another preferred embodiment of the invention, means are located upstream of the at least one ID scanner for rotating the vehicle wheel, such that the identification mark is oriented for interception by the ID scanner.

According to another preferred embodiment of the invention, multiple ID scanners are mounted at predetermined locations relative to the moving vehicle wheel.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a side view of a vehicle wheel carried on a powered roller conveyor, and showing a portion of the wheel in cross-section;

FIG. 2 is a top view of the vehicle wheel on the powered roller conveyor;

FIG. 3 is a side sectional view of the vehicle wheel in a first stage reading operation for pre-identification of the wheel according to one preferred embodiment of the invention;

FIG. 4 is a top view of the vehicle wheel after pre-identification and prior to a second stage reading operation;

FIG. 5 is a top view of the vehicle wheel in an angular adjustment zone applicable for orienting the wheel for identification according to second embodiment of the invention;

FIG. 6 is a side sectional view of the vehicle wheel in the first stage reading operation according to a third embodiment of the invention;

FIG. 7 is a top view of the vehicle wheel after pre-identification and prior to the second stage reading operation;

FIG. 8 is a top view of the vehicle wheel in a wheel identification zone comprising a number of strategically arranged scanners applicable for identifying the wheel according to a fourth embodiment of the present invention;

FIG. 9 is a side sectional view of a vehicle wheel including a number of equally spaced identification marks applicable for identifying the wheel according to a fifth embodiment of the invention;

FIG. 9A is an enlarged view of a portion of the inboard rim flange including the wheel identification mark;

FIG. 10 is a top view of the vehicle wheel illustrating in phantom the circumferentially-spaced identification marks applied to the inboard rim flange;

FIG. 11 is a side view of the vehicle wheel illustrating application of the identification marks to the rim barrel of the wheel; and

FIG. 12 is a top view of the vehicle wheel showing the identification marks in phantom.

### DESCRIPTION OF THE PREFERRED EMBODIMENT AND BEST MODE

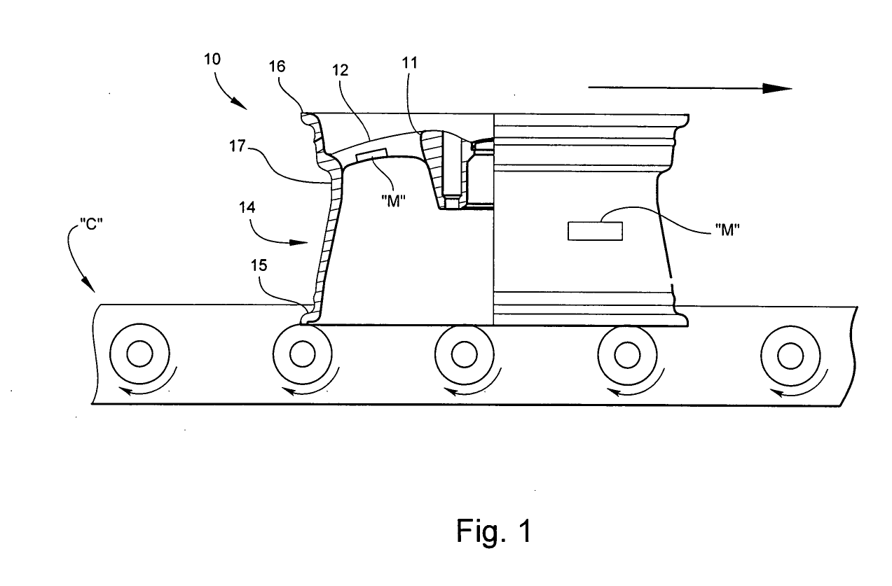

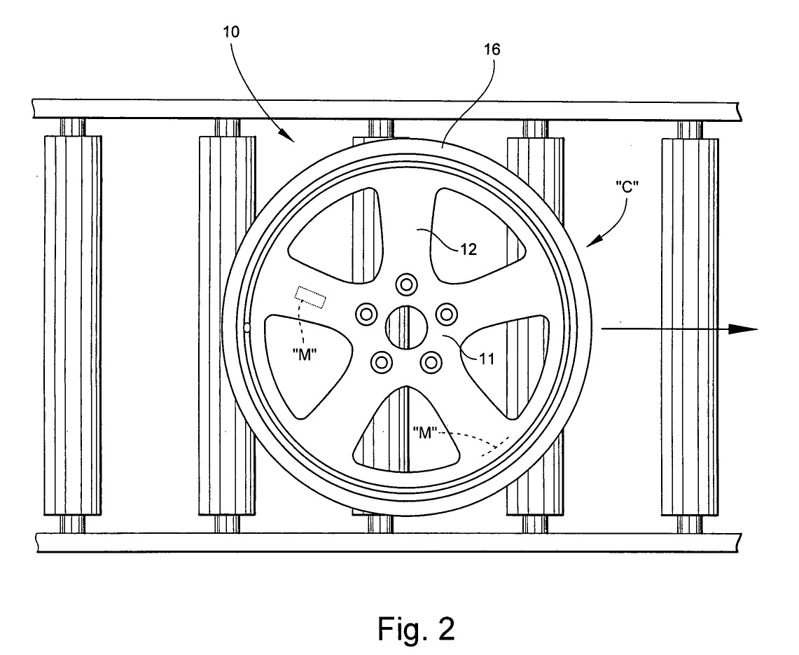

Referring now specifically to the drawings, FIGS. 1 and 2 illustrate a standard cast aluminum wheel 10 applicable for electronic identification according to a method of the present invention. The vehicle wheel 10 comprises an integrally-formed center hub 11, hub spokes 12, and wheel rim 14. The wheel rim 14 has an annular inboard flange 15, an opposing annular outboard flange 16, and a rim barrel 17. The hub spokes 12 and rim areas 14, 15, and 16 are especially suited for application of one or more machine-readable identification marks “M” containing useful information regarding the vehicle wheel 10. This information may include, for example, the serial number, wheel model, size, mold number, angular orientation, and the like.

The wheel 10 is generally processed after casting in a face-up position with the inboard flange 15 resting directly on a powered roller conveyor “C”, as best shown in FIG. 2. The conveyor transports the wheel 10 at speeds in excess of 1 fps. The present method includes locating the identification mark “M” on the wheel 10, and electronically reading the mark “M” on-the-fly as the wheel 10 moves downstream from one processing location to the next. Typical wheel processing includes deflashing (fettling), desprueing, fluoroscopic inspection, solution heat-treatment, quenching, aging heat-treatment, shot blasting, painting, machining, clear coating and final inspection.

The wheel identification mark is preferably a keyless bar code which is either laser-formed or peened using a direct part marking (DPM) process. In one embodiment, the identification mark is a Data Matrix code. This mark codes data based on the position of black spots within a 2-D matrix on a light background. Each black element is the same dimension, and it is the position of the element that codes the data. In another embodiment, the mark is an embossed three-dimensional bar code which can be read by using differences in height, rather than contrast, to distinguish between bars and spaces using a special reader. Alternatively, controlled lighting can be used to enhance contrast for more conventional machine vision reading. This code is particularly useful where printed labels will not adhere, or would be otherwise destroyed by a hostile or abrasive environment. Other suitable machine-readable code includes PosiCode, Dot Code A, USD5, QR Code, UltraCode, and SuperCode.

The wheel identification mark is read by using either one or more laser line scanners, other appropriate non-contact distance readers, or by conventional fixed focus optical vision scanners operatively positioned adjacent the roller conveyor. Standard line of sight tracking systems require the wheel identification mark to be presented within the scanner's field of view. While several non-contact distance reading technologies are suitable, to get high resolution the distance variation of the mark to the scanner (depth of field, or DOF) must be kept within a relatively tight range—usually under 50 mm. The field of view (FOV) of such high-resolution scanners is also relatively limited—in the sub 100 mm range. The DOF and FOV of optical vision scanners are significantly less-especially the DOF. The wheel identification mark, which can be any size but is typically in the 10 mm range, is preferably read when perpendicular to and in the same plane as the scanner.

The scanner's required resolution is directly related to the density of the bar code. For example, the higher the density of the bar code, the higher the scanner's resolution has to be to read a symbol. Generally, the lower the density of the bar code, the farther away the scanner can be to read a symbol. To account for certain inherent limitations and inaccuracies, the newest laser scanners employ “fuzzy logic” technology. This technology applies artificial intelligence to reading poorly printed bar codes and is ideal for low-contrast, high density bar codes. Fuzzy logic offers the highest level of performance and best first-time read rate across a range of bar code qualities including harsh environments and rugged operating conditions. Other applicable scanner processing technologies include optical character recognition/intelligent character recognition readers (for OCR fonts).

The concept of the present method is to locate and read the wheel identification mark “M” on-the-fly during processing without slowing or stopping downstream forward movement of the vehicle wheel 10. The concept is achieved in the various embodiments discussed below. The vehicle wheel 10 and its several components will be referenced below using the numerals discussed above and indicated in FIGS. 1 and 2. In addition, for each of the various embodiments, the reference letters “M”, “S”, and “C” will be used generically to refer to the wheel identification marks, scanners, and roller conveyor, respectively.

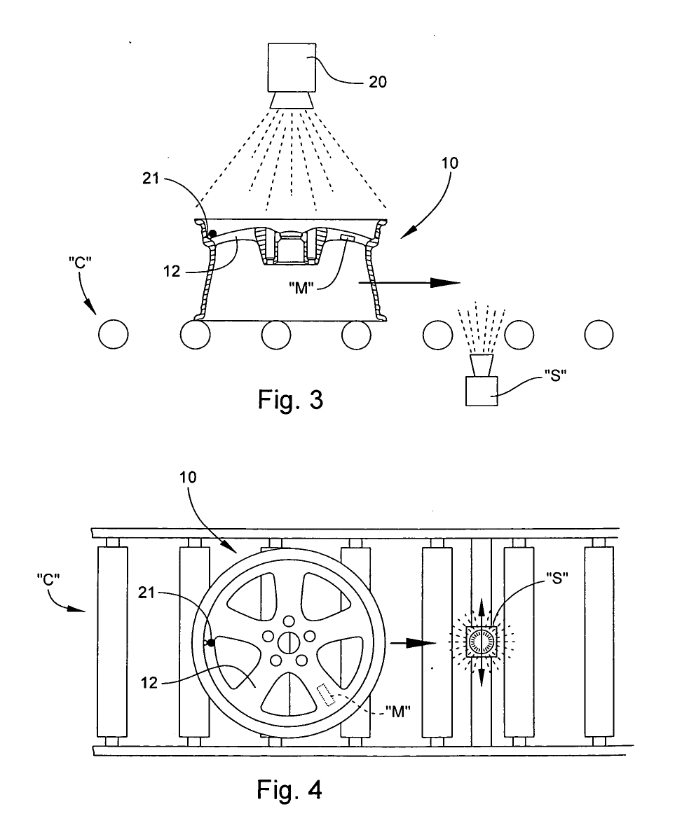

Referring to the identification system illustrated in FIGS. 3 and 4, as the vehicle wheel 10 is moved downstream on the roller conveyor “C”, an overhead camera 20 captures a digital image of the wheel 10 and electronically determines its model type based on a comparison of stored information contained in a wheel model database. Motion sensors or other suitable means (not shown) are employed to activate the camera 20 at a precise location of the wheel 10. Based on the particular wheel model and using a reference point 21 on the face-side of the wheel 10, the information determined by the camera 20 is electronically assimilated to locate the wheel identification mark “M”. The mark “M” is preferably consistently applied in an exact location relative to the reference point 21 for each of the various wheel models. In the present example, the identification mark “M” is formed with the underside of a hub spoke 12.

Once the location of the identification mark “M” is determined, the camera 20 transmits an adjustment signal to a downstream scanner “S”. The signal automatically adjusts the scanner's DOF to that required for the particular wheel model, and effects sliding lateral movement of the scanner “S” along a cross-guide to properly arrange its FOV in precise vertical alignment with the location of the wheel identification mark “M”. As the wheel 10 passes vertically over the scanner “S”, the identification mark “M” is read by the scanner “S” and the wheel information relayed to downstream processing locations. The identification mark “M” is electronically read on-the-fly without slowing or stopping forward movement of the vehicle wheel 10.

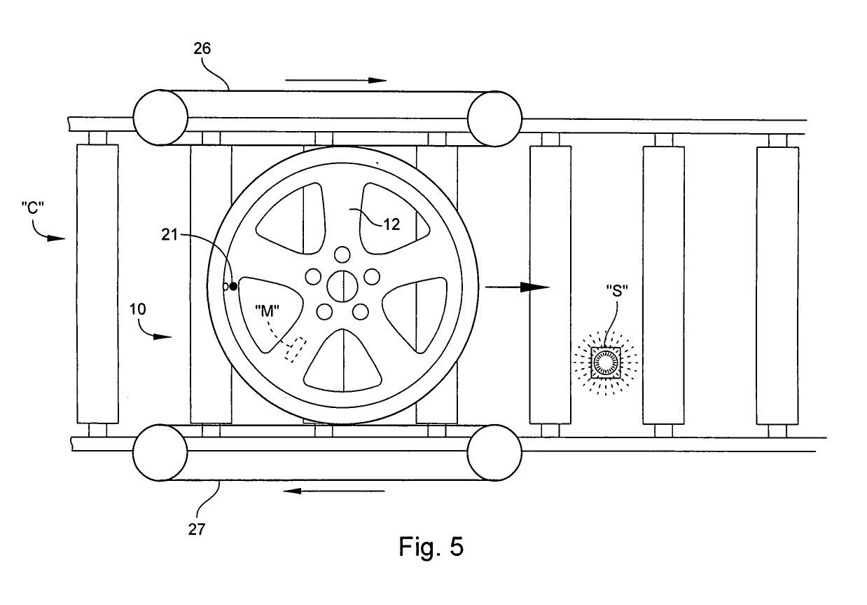

As an alternative to the sliding scanner, discussed above, laterally-opposing angular adjustment belts 26 and 27 shown in FIG. 5 may be employed to rotate the wheel 10 on-the-fly according to wheel model and orientation data transmitted by the camera 20. In this embodiment, the wheel 10 is rotated a precise degree relative to a fixed scanner “S” in order to position the identification mark “M” within the scanner's FOV as the wheel 10 is conveyed past the scanner “S”. The belts 26, 27 cooperate to adjust the orientation of the wheel 10 without stopping or slowing the roller conveyor “C”.

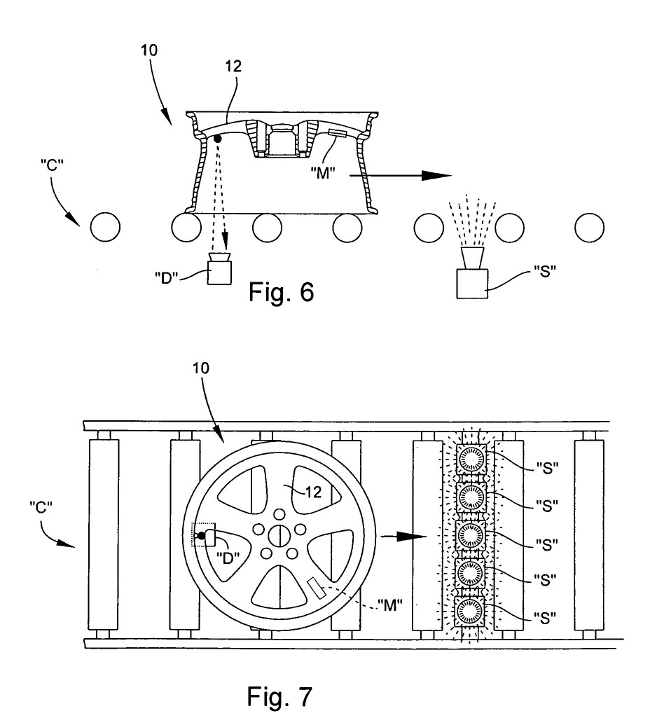

A third embodiment of the present system is illustrated in FIGS. 6 and 7. The wheel identification mark “M” is applied to the underside of a hub spoke 12, as previously described. As the vehicle wheel 10 is moved downstream on the roller conveyor “C”, an under-mounted distance measurement device “D” determines the exact distance between the device and the underside of the hub spoke 12. Motion sensors or other suitable means (not shown) are employed to activate the device “D”. This distance measurement is then transmitted to a series of laterally-spaced scanners “S” having respective overlapping fields of view. Based on the transmitted distance, the DOF is automatically adjusted for each of the scanners “S”. As the wheel 10 passes vertically over the scanners “S”, the identification mark is electronically read by at least one of the scanners “S” and the wheel information relayed to downstream processing locations. The identification mark “M” is read by the scanner “S” on-the-fly without slowing or stopping forward movement of the vehicle wheel 10.

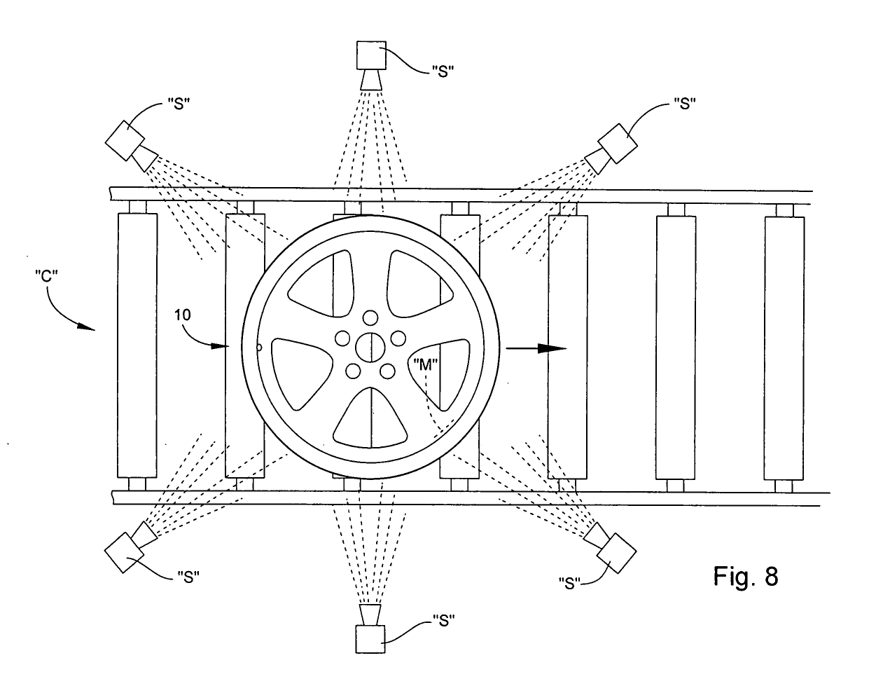

FIG. 8 illustrates a fourth embodiment of the wheel identification system. According to this embodiment, the wheel identification mark “M” is applied to an outer surface of the rim barrel 17. While moving downstream on the roller conveyor “C”, the wheel 10 enters an identification zone comprising a number of side-mounted strategically arranged scanners “S” operable for reading the entire outer circumferential surface area of the wheel 10. The identification mark “M” is located and electronically read by at least one of the scanners “S” regardless of the wheel's orientation on the roller conveyor “C”, and without slowing or stopping the wheel 10.

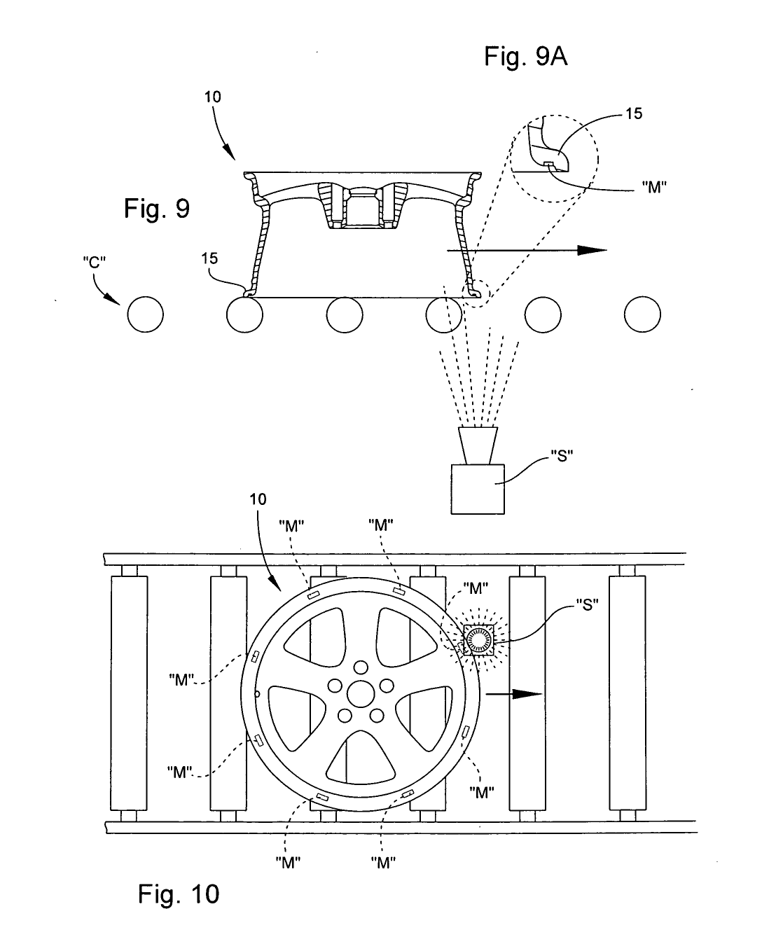

FIGS. 9, 9A and 10 illustrate application of the present method in a vehicle wheel 10 with eight identical, circumferentially-spaced identification marks “M” formed with its inboard flange 15. The identification marks “M” are equally spaced 45-degrees apart. As shown in FIG. 9, the scanner “S” is under-mounted below the roller conveyor “C”. As the wheel 10 moves past the scanner “S”, at least one of the marks “M” is captured within the scanner's FOV. The scanner “S” reads the identification mark “M” without stopping or slowing forward movement of the vehicle wheel 10, and electronically relays this information to downstream processing locations.

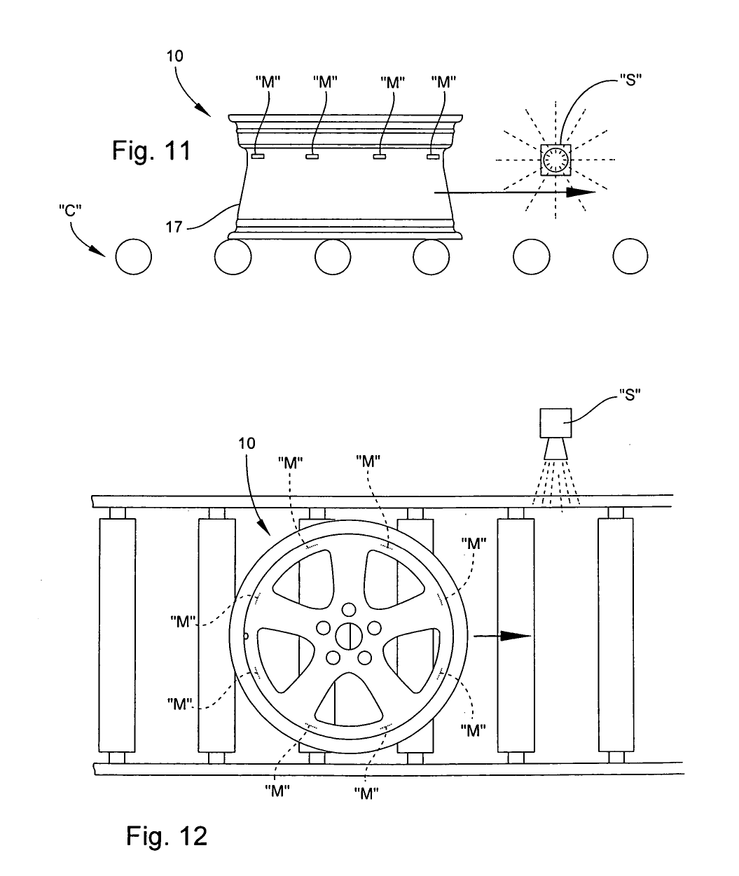

This multiple mark concept is further illustrated in FIGS. 11 and 12. In this embodiment, eight identical, circumferentially-spaced identification marks “M” are applied to the rim barrel 17 of the vehicle wheel 10. The scanner “S” is mounted to the side of the roller conveyor “C”. As the wheel 10 moves past the scanner “S”, at least one of the marks “M” is captured within the scanner's FOV. The scanner “S” reads the identification mark “M” without stopping or slowing forward movement of the vehicle wheel 10, and electronically relays this information to downstream processing locations.

A further concept of the present method and system, discussed generally in reference to FIGS. 3 and 4, is the ability to determine the angular orientation of the wheel on-the-fly for purposes other than locating the identification mark. Knowing the precise wheel orientation is especially critical during certain operations, such as lug hole drilling. In the embodiments of FIGS. 6-12, either multiple scanners and a single identification mark (FIGS. 6-8) or multiple identification marks and a single scanner (FIGS. 9-12) are used to automate wheel identification without stopping or slowing forward movement of the wheel. In the case of multiple scanners, general wheel orientation is determined by identifying which scanner locates the mark. For each of the various wheel models, the single identification mark is consistently applied in an exact location relative to a predetermined reference point on the wheel, such as the valve hole perch. In the case of multiple identification marks, wheel orientation is determination by identifying the location of the particular mark read by the scanner relative to the reference point on the wheel. Each mark includes a different code indicating its location relative to the reference point. For each of the various wheel models, the identification marks are consistently located an exact spaced-apart distance relative to each other, and relative to the reference point.

A method and system for electronically identifying a vehicle wheel on-the-fly during manufacture is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A method for electronically identifying a vehicle wheel on-the-fly moving downstream from one processing location to another, said method comprising the steps of:
(a) as the vehicle wheel moves downstream, locating a machine-readable identification mark applied to an exposed surface of the vehicle wheel; and
(b) electronically reading the identification mark on-the-fly.

2. A wheel identification method according to claim 1, and comprising a first stage reading operation for locating the machine-readable identification mark on the moving vehicle wheel.

3. A wheel identification method according to claim 2, and comprising a second stage reading operation downstream of said first stage reading operation for electronically reading the identification mark on the moving vehicle wheel.

4. A wheel identification method according to claim 3, wherein the second stage reading operation comprises mounting multiple ID scanners at predetermined locations relative to the moving vehicle wheel.

5. A wheel identification method according to claim 3, wherein the second stage reading operation comprises mounting a single ID scanner at a predetermined location relative to the moving vehicle wheel.

6. A wheel identification method according to claim 5, and comprising adjusting the location of the ID scanner relative to the moving vehicle wheel, such that the scanner intercepts the identification mark applied to the vehicle wheel.

7. A wheel identification method according to claim 3, and comprising rotating the vehicle wheel between the first and second stage reading operations, such that the identification mark is oriented for interception by the ID scanner.

8. A wheel identification method according to claim 1, and comprising locating at least one of multiple machine-readable identification marks applied to a circumference of the vehicle wheel.

9. A wheel identification method according to claim 8, wherein the vehicle wheel comprises at least three circumferentially-spaced, machine-readable identification marks.

10. A wheel identification method according to claim 9, wherein the identification marks are applied to a rim barrel of the vehicle wheel.

11. A wheel identification method according to claim 9, wherein the identification marks are applied to a rim flange of the vehicle wheel.

12. A wheel identification system for electronically identifying a vehicle wheel on-the-fly moving downstream from one processing location to another, said system comprising:
(a) means for locating a machine-readable identification mark applied to an exposed surface of the vehicle wheel; and
(b) at least one ID scanner for electronically reading the identification mark on-the-fly as the vehicle wheel moves downstream.

13. A wheel identification system according to claim 12, wherein said means for locating the identification mark comprises a camera mounted upstream of said at least one ID scanner.

14. A wheel identification system according to claim 12, and comprising means for adjusting the location of said at least one ID scanner relative to the moving vehicle wheel, such that said ID scanner intercepts the identification mark applied to the vehicle wheel.

15. A wheel identification system according to claim 12, and comprising means located upstream of said at least one ID scanner for rotating the vehicle wheel, such that the identification mark is oriented for interception by the ID scanner.

16. A wheel identification system according to claim 12, and comprising multiple ID scanners mounted at predetermined locations relative to the moving vehicle wheel.
